(19) United States
(12) Patent Application Publication
(10) Pub. No.: US 2017/0280268 A1
(43) Pub. Date: Sep. 28, 2017

(54) METHOD AND ELECTRONIC DEVICE FOR PROCESSING DATA

(71) Applicants: LE HOLDINGS (BEIJING) CO., LTD., Beijing (CN); LEMOBILE INFORMATION TECHNOLOGY (BEIJING) CO., LTD, Beijing (CN)

(72) Inventor: Jianjun Wei, Beijing (CN)

(21) Appl. No.: 15/242,424

(22) Filed: Aug. 19, 2016

Related U.S. Application Data
(63) Continuation of application No. PCT/CN2016/089192, filed on Jul. 7, 2016.

(30) Foreign Application Priority Data
Mar. 28, 2016 (CN) 201610184582.2

(51) Int. Cl. H04W 4/00

(52) U.S. Cl. CPC H04W 4/001; H04W 4/008; H04W 88/02

(57) ABSTRACT

The present disclosure relates to a method and electronic device for processing data. The method includes: invoking a changing module in a terminal; obtaining to-be-sent data on the terminal by the changing module; establishing NFC connection between the terminal and a preset receiving terminal; and sending the to-be-sent data to the preset receiving terminal by the NFC. Thus, when a user wants to transfer related data in an old phone to a new phone, by the above method, the related data in the old phone may be sent to the new phone quickly through the NFC connection, thereby avoiding complex operation in known techniques.

### CROSS REFERENCE TO RELATED APPLICATION

The application is a continuation of International Application No. PCT/CN2016/089192 filed on Jul. 7, 2016 (attached hereto as an Appendix), which is based upon and claims priority to Chinese Patent Application No. 201610184582.2 filed on Mar. 28, 2016, all of which are incorporated herein by reference in entirety.

### BACKGROUND

Field

The present disclosure relates to the field of communication technology, and in particular, to a method and electronic device for processing data.

Description of Related Information

With the development of technology, there are more and more terminal products for users, and a cycle of changing terminal products by users becomes shorter and shorter. How to transfer data such as important documents and so on stored in a terminal by a user to a new terminal safely and quickly, has become a most practical problem. However, generally, two terminals are connected to a same network, and then data is transferred via the network. However, in this case, a matching should be generally established between the two terminals in order to transfer data, which makes operation too complex.

### Overview of Some Aspects

To overcome the problem in related techniques, the present disclosure provides a method and device for processing data.

According to a first aspect of embodiments of the present disclosure, a method for processing data is provided, which includes:
invoking a changing module in a terminal;
obtaining to-be-sent data on the terminal by the changing module;
establishing NFC connection between the terminal and a preset receiving terminal; and
sending the to-be-sent data to the preset receiving terminal by the NFC.

According to a second aspect of embodiments of the present disclosure, a computer storage medium is further provided, which may store programs. When the programs are executed, the steps in the method for processing data according to the first aspect of the present disclosure may be performed.

According to a third aspect of embodiments of the present disclosure, an electronic device including one or more processors and a memory is provided, wherein the memory is stored with instructions executable by the one or more processors, and the instructions are set to perform the method for pushing information according to the present disclosure.

The technical solutions provided by embodiments of the present disclosure may include the following advantageous effects.

In the method and electronic device for processing data provided by the present disclosure, to-be-sent data in a terminal may be sent to a preset receiving terminal by invoking a changing module in the terminal, obtaining the to-be-sent data on the terminal by the changing module, and establishing NFC connection between the terminal and the preset receiving terminal. Thus, when a user wants to transfer related data in an old phone to a new phone, by the above method, the related data in the old phone may be sent to the new phone quickly through NFC connection, thereby avoiding complex operation in related techniques.

It should be understood that, the above general description and the detailed description hereinafter are merely exemplary and explanatory, which are not used to limit the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for processing data according to an exemplary embodiment;

FIG. 2 is a flow chart of step S120 in FIG. 1;

FIG. 3 is another flow chart of step S120 in FIG. 1;

FIG. 4 is a flow chart of a method for processing data according to an exemplary embodiment;

FIG. 5 is a flow chart of a method for processing data according to an exemplary embodiment;

FIG. 6 is a structure diagram of a device for processing data according to an exemplary embodiment;

FIG. 7 is a schematic diagram of a to-be-sent data obtaining unit in FIG. 6;

FIG. 8 is another schematic diagram of a to-be-sent data obtaining unit in FIG. 6;

FIG. 9 is a structure diagram of a device for processing data according to an exemplary embodiment;

FIG. 10 is a structure diagram of a device for processing data according to an exemplary embodiment; and

FIG. 11 is a schematic structure diagram of an electronic device according to an exemplary embodiment.

### DETAILED DESCRIPTION OF ILLUSTRATIVE IMPLEMENTATIONS

Exemplary embodiments are described in detail herein, examples of which are illustrated in figures. In the following descriptions, unless indicated otherwise, same reference numerals in different figures indicate same or similar elements. The implementations described in the following exemplary embodiments do not represent all implementations according to the present disclosure. On the contrary, they are merely examples of devices and methods according to some aspects of the present disclosure, as defined in the attached claims.

To solve related problems, embodiments of the present disclosure first provide a method for processing data. As shown in FIG. 1, the method may include the following steps.

In step S110, a changing module in a terminal is invoked.

The changing module is preinstalled in the terminal. After a related operation is obtained from a user, the changing module preinstalled in the terminal is enabled.

In step S120, to-be-sent data on the terminal is obtained by the changing module.

Exemplarily, when a user wants to transfer some data in an old phone to a new phone, it is required to obtain to-be-sent data in the old phone that the user wants to send. The to-be-sent data may be for example videos, music and photos that the user adds in advance in the changing module, and may further be data selected temporarily according to operation of the user on the changing module.

In step S130, near field communication (NFC) connection is established between the terminal and a preset receiving terminal.

Because many phones at present have the NFC function, when NFC function switches of two phones are turned on and the two phones are put together back to back, the NFC connection between the two phones may be established.

In step S140, the to-be-sent data is sent to the preset receiving terminal by the NFC.

After the NFC connection is established between two terminals, the data to be sent in a sending terminal may be sent, by NFC, to the preset receiving terminal that needs to receive the to-be-sent data. In this way, the preset receiving terminal, after receiving the data sent by the sending terminal, stores the received data in local, which may achieve fast sending and receiving of data between new and old terminals.

In the method for processing data provided by the present disclosure, to-be-sent data in a terminal may be sent to a preset receiving terminal by invoking a changing module in the terminal, obtaining the to-be-sent data on the terminal by the changing module, and establishing NFC connection between the terminal and the preset receiving terminal Thus, when a user wants to transfer related data in an old phone to a new phone, by the above method, the related data in the old phone may be sent to the new phone quickly through NFC connection, thereby avoiding complex operation in related techniques.

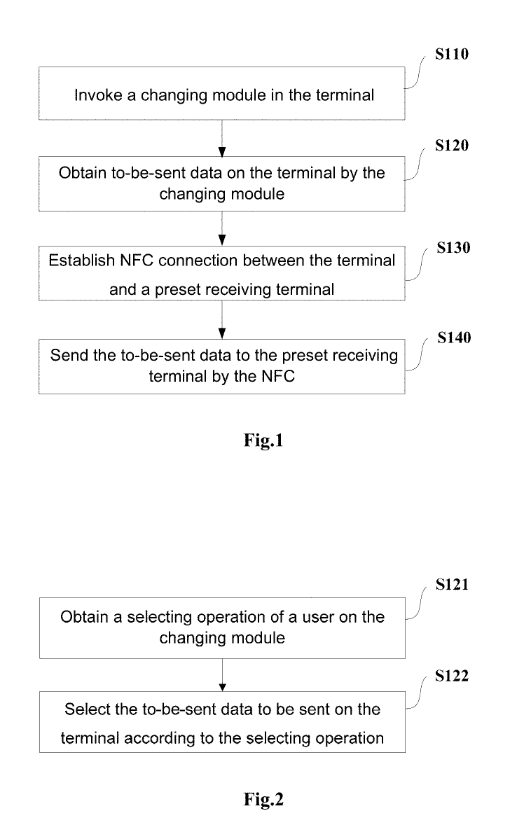

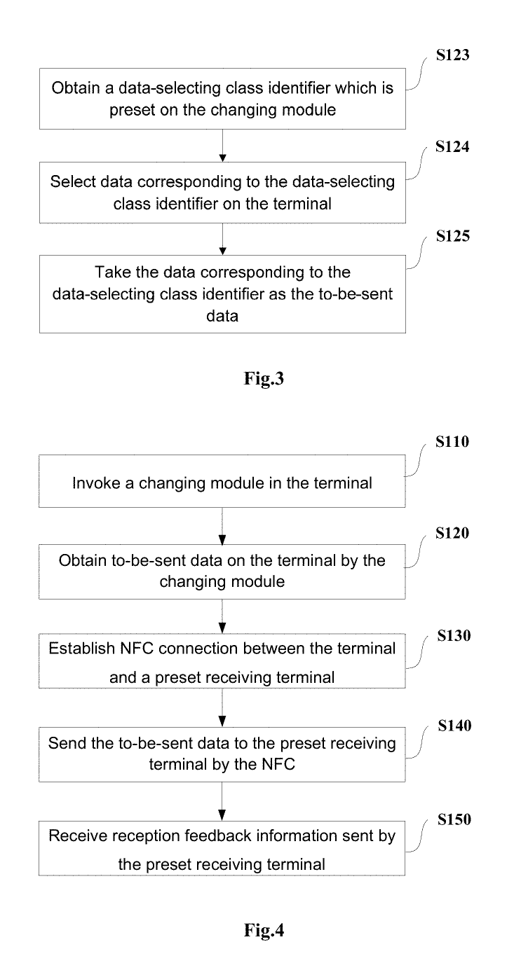

As for the method in FIG. 1, in another embodiment of the present disclosure, referring to FIG. 2, step S120 may further include the following steps.

In step S121, a selecting operation of a user on the changing module is obtained.

In step S122, the to-be-sent data required to be sent on the terminal is selected according to the selecting operation.

In the embodiment, the to-be-sent data required to be sent on the terminal is selected by the selecting operation of the user on the changing module. Exemplarily, all data identifiers on the terminal may be displayed on the displaying screen by the changing module. The user may check the data identifiers required to be sent by the selecting operation and take the data corresponding to the checked data identifiers as the to-be-sent data.

As for the method in FIG. 1, in another embodiment of the present disclosure, referring to FIG. 3, step S120 may further include the following steps.

In step S123, a data-selecting class identifier which is preset on the changing module is obtained.

In step S124, data corresponding to the data-selecting class identifier on the terminal is selected.

In step S125, the data corresponding to the data-selecting class identifier is taken as the to-be-sent data.

In the present embodiment, a class identifier of data required to be sent may be preset on the changing module. Exemplarily, class identifiers of videos, music or photos in phones are added into the changing module, respectively, so that the changing module has to-be-sent data required to be sent by default. In this way, after the above class identifiers are obtained, it only needs to take data corresponding to the class identifiers as to-be-sent data.

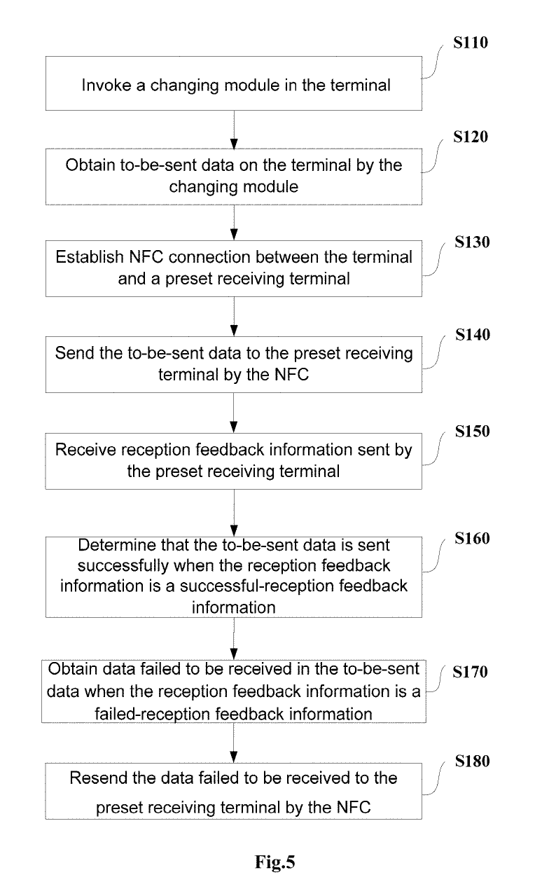

As for the method in FIG. 1, in another embodiment of the present disclosure, referring to FIG. 4, the method may further include the following steps.

In step S150, reception feedback information sent by the preset receiving terminal is received.

The receiving feedback information may include successful-reception feedback information or failed-reception feedback information.

In this way, after sending the to-be-sent data to the preset receiving terminal, the terminal needs the receiving feedback information sent by the preset receiving terminal to determine whether the preset receiving terminal receives the to-be-sent data sent by the terminal successfully.

As for the method in FIG. 4, in another embodiment of the present disclosure, referring to FIG. 5, the method may further include the following steps.

In step S160, it is determined that the to-be-sent data is sent successfully when the reception feedback information is the successful-reception feedback information.

In step S170, data failed to be received in the to-be-sent data is obtained when the reception feedback information is the failed-reception feedback information.

In step S180, the data failed to be received is resent to the preset receiving terminal by the NFC.

The reception feedback information includes the successful-reception feedback information or the failed-reception feedback information. If the reception feedback information received by the preset receiving terminal is the successful-reception feedback information, it means that the preset receiving terminal receives the to-be-sent data sent by the terminal successfully and the process of sending data is completed. If the reception feedback information received by the preset receiving terminal is the failed-reception feedback information, it means that the preset receiving terminal fails to receive the to-be-sent data sent by the terminal, and thus it is required to resend the data that the terminal fails to send to the preset receiving terminal until all the to-be-sent data is sent successfully.

In the method for processing data provided by the disclosure, to-be-sent data in a terminal may be sent to a preset receiving terminal by invoking a changing module in the terminal, obtaining the to-be-sent data on the terminal by the changing module, and establishing NFC connection between the terminal and the preset receiving terminal Thus, when a user wants to transfer related data in an old phone to a new phone, by the above method, the related data in the old phone may be sent to the new phone quickly through NFC connection, thereby avoiding complex operation in related techniques.

According to the description of the above method embodiments, it can be clearly understood by ordinary skill in the art that the present disclosure can be implemented by means of software along necessary universal hardware platform, certainly, may further be implemented by means of hardware, however in most cases, the former is better. Based on such understanding, the part in the technical solutions of the present disclosure that virtually makes a contribution to the prior art may be embodied in a form of a software product, which can be stored in a storage medium and includes several instructions for allowing a computer device (which may be a personal computer, a server, a network device or the like) to perform part or all of the steps in the methods described in various embodiments of the present disclosure. The above storage medium may include various mediums such as read-only memory (ROM), random access memory (RAM), magnetic disk and CD, etc. which may storage program codes.

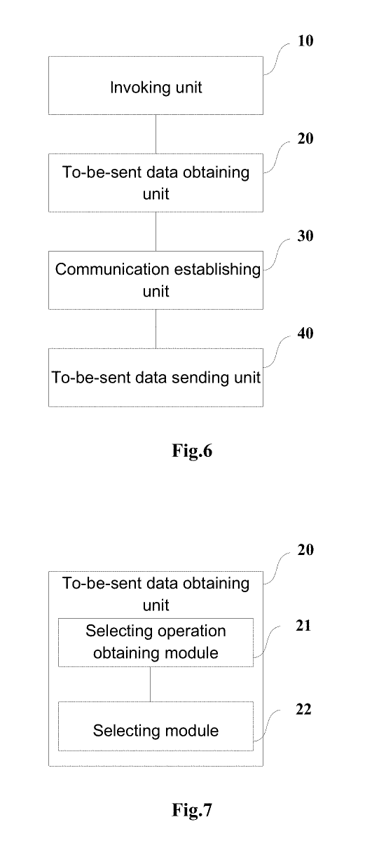

Additionally, as for the implementation of the above respective embodiments, embodiments of the present disclosure further provides a device for processing data, which may be disposed in a terminal. As shown in FIG. 6, the device includes:
an invoking unit 10, configured to invoke a changing module in the terminal;
a to-be-sent data obtaining unit 20, configured to obtain to-be-sent data on the terminal by the changing module;
a communication establishing unit 30, configured to establish NFC connection between the terminal and a preset receiving terminal; and
a to-be-sent data sending unit 40, configured to send the to-be-sent data to the preset receiving terminal by the NFC.

In yet another embodiment of the present disclosure based on FIG. 6, as shown in FIG. 7, the to-be-sent data obtaining unit 20 includes:
a selecting operation obtaining module 21, configured to obtain a selecting operation of a user on the changing module; and
a selecting module 22, configured to select to-be-sent data required to be sent on the terminal according to the selecting operation.

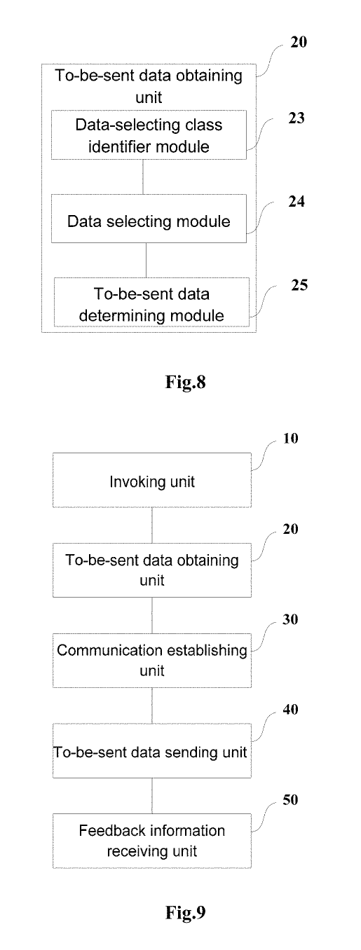

In yet another embodiment of the present disclosure based on FIG. 6, as shown in FIG. 8, the to-be-sent data obtaining unit 20 includes:
a data-selecting class identifier module 23, configured to obtain a data-selecting class identifier which is preset on the changing module;
a data selecting module 24, configured to select data corresponding to the data-selecting class identifier on the terminal; and
a to-be-sent data determining module 25, configured to take the data corresponding to the data-selecting class identifier as the to-be-sent data.

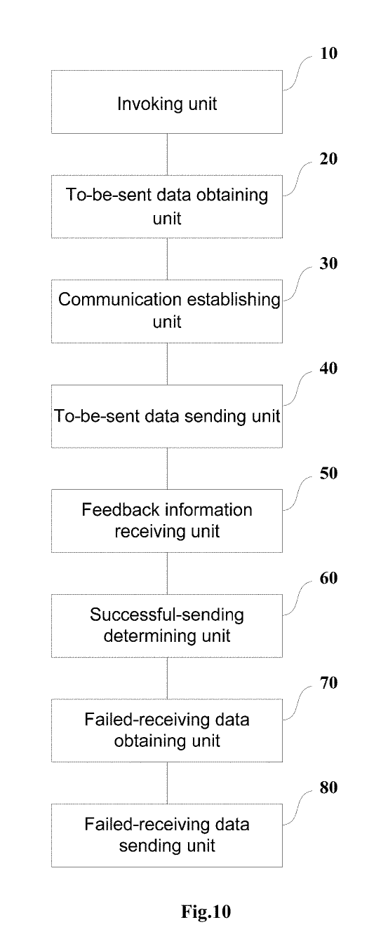

In yet another embodiment of the present disclosure based on FIG. 6, as shown in FIG. 9, the device further includes:
a feedback information receiving unit 50, configured to receive reception feedback information, including successful-reception feedback information or failed-reception feedback information, sent by the preset receiving terminal.

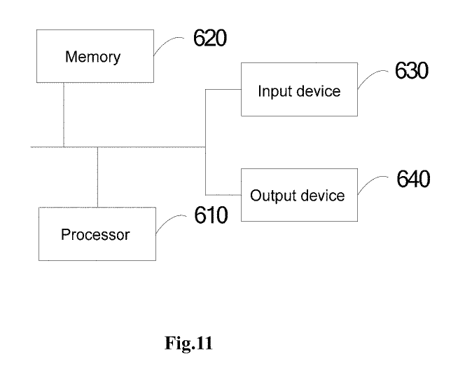

In yet another embodiment of the present disclosure based on FIG. 9, as shown in FIG. 10, the device further includes:
a successful-sending determining unit 60, configured to determine that the to-be-sent data is sent successfully when the reception feedback information is the successful-reception feedback information;
a failed-receiving data obtaining unit 70, configured to obtain data failed to be received in the to-be-sent data when the reception feedback information is the failed-reception feedback information; and
a failed-receiving data sending unit 80, configured to resend the data failed to be received to the preset receiving terminal by the NFC.

With respect to the devices in above embodiments, the specific manner in which the operation of each module is performed has been described in details in the embodiments relevant to the method, and will not be illustrated herein in detail.

In the device for processing data provided by the disclosure, to-be-sent data in a terminal may be sent to a preset receiving terminal by invoking a changing module in the terminal, obtaining the to-be-sent data on the terminal by the changing module, and establishing NFC connection between the terminal and the preset receiving terminal Thus, when a user wants to transfer related data in an old phone to a new phone, by the above method, the related data in the old phone may be sent to the new phone quickly through NFC connection, thereby avoiding complex operation in related techniques.

It may be understood that, the present disclosure may be applied to many general or special computing system environments or configurations, such as a personal computer, server computer, handheld device or portable device, flat-plate device, multiprocessor system, system based on microprocessor, set-top box, programmable consumer electronic device, network PC, minicomputer, main-frame computer, and distributed computing environments including any of above systems or devices, etc..

The present disclosure may be described in general context of computer executable instructions executed by computers, such as a program module. Generally, the program module may include routine, program, object, assembly, data structure and the like which perform a specific task or achieve a specific abstract data type. Also, the present disclosure may be practiced in distributed computing environments, in which tasks are performed by a remote processing device connected by communication network. In the distributed computing environments, the program module may be disposed in computer storage medium in local and remote devices including storage devices.

It should also be noted that, herein, relational terms such as “first” and “second”, etc., are only used to distinguish one entity or operation from another entity or operation, and may not require or indicate that there is any practical relation or sequence between these entities or operations. Moreover, terms “include”, “comprise” or any variant thereof intend to encompass non-exclusive “comprise”, so that a process, method, article or device, which includes a series of factors, not only includes such factors, but also includes other factors that are not listed explicitly, or further includes the intrinsic factors of such process, method, article or device. In the case that no further limitation exists, a factor defined by a sentence “include a (an) . . . ” does not exclude that additional alike factors further exist in the process, method, article or device that includes the factor.

In consideration of the description, one of ordinary skilled in the art will readily envisage other embodiments of the present disclosure after practicing the present disclosure disclosed herein. The present application is intended to cover any modification, usage or adaptive variation of the present invention, which are based on general principles of the present disclosure and include common knowledge or conventional technical means in the art not disclosed in the present disclosure. The description and embodiments are merely deemed to be exemplary, and the scope and spirit of the present disclosure are defined by the following claims.

It should be understood that, the present disclosure is not limited to the accurate structure that has been described above and present in drawings. Besides, various modifications and changes may be made without departing from the scope thereof. The scope of the present disclosure is defined by the accompanying claims only.

Embodiments of the present disclosure further provide a computer storage medium which may be stored with programs that, when being executed, cause part or all of the steps in each of implementations of the methods for proceeding data provided by the embodiments shown in FIGS. 1-5 to be performed.

FIG. 11 is a schematic structure diagram of an electronic device for a method for processing data according to an embodiment of the present disclosure. As shown in FIG. 11, the device includes one or more processors 610 and a memory 620, and FIG. 11 illustrates one processor 610 as an example.

The device for a method for processing data may further include an input device 630 and an output device 640.

The processor 610, memory 620, input device 630 and output device 640 may be connected with each other through bus or other forms of connections. FIG. 11 illustrates bus connection as an example.

As a non-volatile computer readable storage medium, the memory 620 may be configured to store non-volatile software program, non-volatile computer executable program and modules, such as program instructions/modules corresponding to the method for processing data according to the embodiments of the present disclosure. By executing the non-volatile software program, instructions and modules stored in the memory 620, the processor 610 may perform various functional applications of a server and data processing, that is, the method for processing data according to the above method embodiments.

The memory 620 may include a program storage area and a data storage area, the program storage area may be stored with an operating system and applications which are needed by at least one functions, and the data storage area may be stored with data which is created according to use of the device for processing data. Further, the memory 620 may include a high-speed random access memory, and may further include non-volatile memory, such as at least one of disk memory device, flash memory device or other types of non-volatile solid state memory device. In some embodiments, optionally, the memory 620 may include memory provided remotely from the processor 610, and such memory may be connected with the device for processing data through network connections. The examples of the network connections may include but not limited to internet, intranet, LAN (Local Area Network), mobile communication network or combinations thereof.

The input device 630 may receive inputted digital or character information, and generate key signal input related to the user settings and functional control of the device for processing data. The output device 640 may include a display device such as a display screen.

The above one or more modules may be stored in the memory 620, when these modules are executed by the one or more processor 610, the method for processing data according to any one of the above mentioned method embodiments may be performed.

The above product may perform the methods provided in the embodiments of the present disclosure, include functional modules corresponding to these methods and advantageous effects. Further technical details which are not described in detail in the present embodiment may refer to the methods provided according to embodiments of the disclosure.

The electronic device in embodiments of the present disclosure may be embodied in various forms, including but not limited to:
(1) mobile communication device, characterized in having a function of mobile communication and mainly aimed at providing speech and data communication, wherein such terminal includes: smart phone (such as iPhone), multimedia phone, functional phone, low end phone and the like;
(2) ultra mobile personal computer device, which falls in a scope of personal computer, has functions of calculation and processing, and generally has characteristics of mobile internet access, wherein such terminal includes: PDA, MID and UMPC devices, such as iPad;
(3) portable entertainment device, which can display and play multimedia contents, and includes audio or video player (such as iPod), portable game console , E-book and smart toys and portable vehicle navigation device;
(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and
(5) other electronic devices having a function of data interaction.

The above mentioned embodiments for the device are merely illustrative, wherein the unit illustrated as a separated component may be or may not be physically separated, the component illustrated as a unit may be or may not be a physical unit, in other words, may be either disposed in a same place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to perform the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

1. A method for processing data, which is applied to a terminal, comprising:
invoking a changing module in the terminal;
obtaining to-be-sent data on the terminal by the changing module;
establishing near filed communication NFC connection between the terminal and a preset receiving terminal; and
sending the to-be-sent data to the preset receiving terminal by the NFC.

2. The method for processing data according to claim 1, wherein the obtaining to-be-sent data on the terminal by the changing module comprises:
obtaining a selecting operation of a user on the changing module; and
selecting the to-be-sent data to be sent on the terminal according to the selecting operation.

3. The method for processing data according to claim 1, wherein the obtaining to-be-sent data on the terminal by the changing module comprises:
obtaining a data-selecting class identifier which is preset on the changing module;
selecting data corresponding to the data-selecting class identifier on the terminal; and
taking the data corresponding to the data-selecting class identifier as the to-be-sent data.

4. The method for processing data according to claim 1, further comprising:
receiving reception feedback information, comprising successful-reception feedback information or failed-reception feedback information, sent by the preset receiving terminal.

5. The method for processing data according to claim 4, further comprising:
determining that the to-be-sent data is sent successfully when the reception feedback information is the successful-reception feedback information;
obtaining data failed to be received in the to-be-sent data when the reception feedback information is the failed-reception feedback information; and
resending the data failed to be received to the preset receiving terminal by the NFC.

6. A non-volatile computer-readable storage medium, which is stored with computer executable instructions that, when executed by an electronic device, cause the electronic device to:
invoke a changing module in the terminal;
obtain to-be-sent data on the terminal by the changing module;
establish near field communication NFC connection between the terminal and a preset receiving terminal; and
send the to-be-sent data to the preset receiving terminal by the NFC.

7. The non-volatile computer-readable storage medium according to claim 6, wherein the obtaining to-be-sent data on the terminal by the changing module comprises:
obtaining a selecting operation of a user on the changing module; and
selecting the to-be-sent data to be sent on the terminal according to the selecting operation.

8. The non-volatile computer-readable storage medium according to claim 6, wherein the obtaining to-be-sent data on the terminal by the changing module comprises:
obtaining a data-selecting class identifier which is preset on the changing module;
selecting data corresponding to the data-selecting class identifier on the terminal; and
taking the data corresponding to the data-selecting class identifier as the to-be-sent data.

9. The non-volatile computer-readable storage medium according to claim 6, wherein the electronic device is caused further to:
receive reception feedback information, comprising successful-reception feedback information or failed-reception feedback information, sent by the preset receiving terminal.

10. The non-volatile computer-readable storage medium according to claim 9, wherein the electronic device is caused further to:
determine that the to-be-sent data is sent successfully when the reception feedback information is the successful-reception feedback information;
obtain data failed to be received in the to-be-sent data when the reception feedback information is the failed-reception feedback information; and
resend the data failed to be received to the preset receiving terminal by the NFC.

11. An electronic device, comprising:
at least one processor; and
a memory, communicably connected with the at least one processor and storing instructions executable by the at least one processor,
wherein execution of the instructions by the at least one processor causes the at least one processor to:
invoke a changing module in the terminal;
obtain to-be-sent data on the terminal by the changing module;
establish near field communication NFC connection between the terminal and a preset receiving terminal; and
send the to-be-sent data to the preset receiving terminal by the NFC.

12. The non-volatile computer-readable storage medium according to claim 11, wherein the obtaining to-be-sent data on the terminal by the changing module comprises:
obtaining a selecting operation of a user on the changing module; and
selecting the to-be-sent data to be sent on the terminal according to the selecting operation.

13. The non-volatile computer-readable storage medium according to claim 11, wherein the obtaining to-be-sent data on the terminal by the changing module comprises:
obtaining a data-selecting class identifier which is preset on the changing module;
selecting data corresponding to the data-selecting class identifier on the terminal; and
taking the data corresponding to the data-selecting class identifier as the to-be-sent data.

14. The non-volatile computer-readable storage medium according to claim 11, wherein the at least one processor is caused further to:
receive reception feedback information, comprising successful-reception feedback information or failed-reception feedback information, sent by the preset receiving terminal.

15. The non-volatile computer-readable storage medium according to claim 14, wherein the at least one processor is caused further to:
determine that the to-be-sent data is sent successfully when the reception feedback information is the successful-reception feedback information;
obtain data failed to be received in the to-be-sent data when the reception feedback information is the failed-reception feedback information; and
resend the data failed to be received to the preset receiving terminal by the NFC.

16. The method for processing data according to claim 2, further comprising:
receiving reception feedback information, comprising successful-reception feedback information or failed-reception feedback information, sent by the preset receiving terminal.

17. The method for processing data according to claim 2, wherein the obtaining to-be-sent data on the terminal by the changing module comprises:
obtaining a data-selecting class identifier which is preset on the changing module;
selecting data corresponding to the data-selecting class identifier on the terminal; and
taking the data corresponding to the data-selecting class identifier as the to-be-sent data.

18. The method for processing data according to claim 17, further comprising:
receiving reception feedback information, comprising successful-reception feedback information or failed-reception feedback information, sent by the preset receiving terminal.

19. The method for processing data according to claim 18, further comprising:
determining that the to-be-sent data is sent successfully when the reception feedback information is the successful-reception feedback information;
obtaining data failed to be received in the to-be-sent data when the reception feedback information is the failed-reception feedback information; and
resending the data failed to be received to the preset receiving terminal by the NFC.
